(19) United States
(12) Patent Application Publication
(10) Pub. No.: US 2026/0002654 A1
(43) Pub. Date: Jan. 1, 2026

(54) HEAT SINK FOR A MOTOR VEHICLE LIGHT MODULE AND LIGHT MODULE FOR A MOTOR VEHICLE

(71) Applicant: VALEO VISION, Bobigny (FR)

(72) Inventors: Florent BAUDOUIN, Bobigny (FR); Jean Christophe THIMOUY, Bobigny (FR)

(73) Assignee: VALEO VISION, Bobigny (FR)

(21) Appl. No.: 18/993,297

(22) PCT Filed: Jul. 10, 2023
(86) PCT No.: PCT/EP2023/069030

§ 371 Date: Jan. 10, 2025

(30) Foreign Application Priority Data
Jul. 11, 2022 (FR) FR2207104

(51) Int. Cl. F21S 45/47

(52) U.S. Cl. CPC F21S 45/47

(57) ABSTRACT

The invention relates to a heat sink of a luminous module for an automotive vehicle. The heat sink includes at least one protruding cooling element extending between a foot and a free end along a direction of extension, and having a thickness along a direction transverse to the direction of extension. The thickness of the protruding cooling element decreasing as it extends from the foot to the free end. The protruding cooling element includes a first portion and a second portion, the first portion being situated between the foot and the second portion, and the second portion being situated between the first portion and the free end, the decrease in the thickness of the protruding cooling element being greater in the second portion than in the first portion. The invention also relates to a luminous module including such a heat sink.

### TECHNICAL FIELD

The invention relates to the field of heat sinks for luminous modules for automotive vehicles. It also relates to luminous modules for automotive vehicles comprising such a heat sink, and particularly automotive vehicle lighting and/or signaling modules.

### BACKGROUND OF THE INVENTION

Automotive vehicle luminous modules, particularly lighting and/or signaling modules, comprise components, such as light sources or elements for controlling the light sources, that emit heat when they are activated. In order to ensure the performance of the luminous modules, these components must be cooled. This is because the overheating of these components, and in particular the overheating of the light sources, can degrade the shape of the light beam emitted by the luminous module.

It is known practice to use heat sinks for cooling the luminous modules. Heat sinks are known in particular that comprise a plurality of fins that extend along a direction of extension between a foot and a free end, and the thickness of which, taken transverse to the direction of extension, decreases continuously from the foot towards the free end. This continuous decrease in thickness of the fins from their foot towards their free end reflects a constant draft angle along each of the two transverse sides of the fins, the draft angle being defined for each of the two transverse sides of the fins by the angle formed between the respective transverse side of the fin and the direction of extension of the fin.

The draft angle typically has a value greater than or equal to 2°, which makes it possible to produce a decrease in thickness of the fins that makes it possible to inject the heat sink and demold the heat sink easily. However, such a heat sink has the drawback of being too bulky to be incorporated into certain luminous modules the footprint of which must be particularly limited.

It is possible to consider reducing the draft angle to an angle of less than 2°, and for example to an angle equal to 1°, while decreasing the thickness of the foot of the fins and retaining the spacing between two successive fins at their feet. The fins can then be brought closer together, and more fins can be positioned in a smaller volume. The footprint of the heat sink is then decreased, and at the same time, the heat dissipation performance of the heat sink remains similar. However, this gives rise to problems in the injection of the heat sink and the demolding of the heat sink.

This is because it is difficult to ensure that the material forming the fins reaches the free ends of the fins during injection due to the small thickness of their feet, and more generally the small thickness of the fins. As a result, the fins do not correctly adopt the shape of the mold used during injection, and are therefore not always the desired shape. In addition, due to the small draft angle, the demolding of the heat sink is difficult, and can lead to problems of wear of the heat sink or of the mold used during injection.

### SUMMARY OF THE INVENTION

The aim of the invention is to overcome at least one of the drawbacks of the aforementioned prior art. More particularly, the aim of the invention is to propose a compact heat sink that makes it possible to dissipate the heat emitted by the components of the luminous module in which it is intended to be mounted, and that is easy to manufacture, in particular easy to inject and demold. Another aim of the invention is to propose a luminous module comprising such a heat sink.

According to a first object, the invention proposes a heat sink of a luminous module for an automotive vehicle, comprising at least one protruding cooling element extending between a foot and a free end along a direction of extension, and having a thickness along a direction transverse to the direction of extension, the thickness of the protruding cooling element decreasing as it extends from the foot to the free end.

The heat sink is notable in that the protruding cooling element comprises a first portion and a second portion, the first portion being situated between the foot and the second portion, and the second portion being situated between the first portion and the free end,
the decrease in the thickness of the protruding cooling element being greater in the second portion than in the first portion.

“Greater decrease in the thickness of the protruding cooling element in the second portion than in the first portion” is given to mean that, considering a part of the first portion having a given height taken along the direction of extension, and a part of the second portion having a height identical to the given height of the part of the first portion, each of the first and second parts having a lower end facing towards the foot of the protruding cooling element and an upper end facing towards the free end of the protruding cooling element, then the difference between the thickness of the protruding cooling element at the lower end of the part of the first portion and the thickness of the protruding cooling element at the upper end of the part of the first portion, is greater than the difference between the thickness of the protruding cooling element at the lower end of the part of the second portion and the thickness of the protruding cooling element at the upper end of the part of the second portion.

The decrease in thickness of the protruding cooling element from its foot to its free end is thus non-constant. As a result, it is possible to design a foot of the protruding element that is sufficiently thick to ensure that the material forming the heat sink passes into the mold during injection, while retaining a limited footprint. This is because, although the thickness of the foot of the protruding element is greater, and therefore has a larger footprint than for a heat sink with a constant draft angle, for example less than 2° all along the transverse sides of the protruding cooling element, having a second portion with a greater decrease in thickness than in the first portion makes it possible to decrease the thickness of the protruding cooling element sufficiently as it extends away from the foot.

According to one variant, the heat sink comprises a plurality of protruding cooling elements along the transverse direction.

Due to the invention, it is possible to position more protruding cooling elements in the same footprint. In order to position more protruding cooling elements in the same footprint, the distance between two successive protruding cooling elements at their feet, taken in the transverse direction, is reduced. However, due to the greater decrease in the thickness of the protruding cooling elements in the second portion than in the first portion, the distance between two successive protruding cooling elements in line with their second portions is greater than the distance between these two successive protruding cooling elements in line with the first portion. In line with the second portion, and therefore closer to the free ends of the protruding cooling elements, the distance between the two protruding cooling elements is thus sufficiently great to promote convection between the protruding cooling elements and thus promote radiation towards the outside of the heat sink. If the protruding cooling elements were too close together, this would hinder convection by pressure drop and cancel out the radiation towards the outside as the radiation would be trapped within the heat sink, between the protruding cooling elements. Due to the invention, the effectiveness of the heat sink is thus retained in a smaller footprint than in the prior art.

According to one variant, the feet of two successive protruding cooling elements are spaced apart along the transverse direction by the same distance.

According to one variant, the protruding cooling element is formed by a fin or a pin.

According to one variant, the protruding cooling element comprises a third portion situated between the second portion and the free end, the decrease in the thickness of the protruding cooling element in the third portion being less than the decrease in the thickness of the protruding cooling element in the second portion.

The second portion is then situated between the first portion and the third portion.

For example, the decrease in the thickness of the protruding cooling element in the third portion can be identical to the decrease in the thickness of the protruding cooling element in the first portion.

According to one variant, the decrease in the thickness of the protruding cooling element is constant in the first portion and in the second portion. Where appropriate, if the protruding cooling element comprises a third portion, the decrease in the thickness of the protruding cooling element can also be constant in the third portion.

The mold used for the injection of the protruding cooling element is then simpler to produce.

According to one variant, the protruding cooling element comprises a first transverse side and a second transverse side, opposite the first transverse side.

For example, the first and second transverse sides correspond to the edges of the protruding cooling element taken on a cross-section of the protruding cooling element in a plane comprising the direction of extension and the transverse direction.

Where appropriate, the first portion comprises a first primary draft angle formed between the first transverse side of the protruding cooling element in the first portion and the direction of extension, and the second portion comprises a second primary draft angle formed between the first transverse side of the protruding cooling element in the second portion and the direction of extension, and the first primary draft angle is smaller than the second primary draft angle. Where appropriate, if the protruding cooling element comprises a third portion, the third portion then comprises a third primary draft angle formed between the first transverse side of the protruding cooling element in the third portion and the direction of extension, the third primary draft angle being smaller than the second primary draft angle, and optionally identical to the first primary draft angle.

According to one variant, the draft angle along a second transverse side of the protruding cooling element, opposite the first transverse side, is constant. “Constant” is given to mean that it is identical for each of the portions.

Alternatively, the first transverse side is symmetrical to the second transverse side with respect to an axis of symmetry parallel to the direction of extension.

The draft angle along the second transverse side of the protruding cooling element then follows the same evolution as the draft angle along the first transverse side of the protruding cooling element. In particular, the first portion comprises a first secondary draft angle formed between the second transverse side of the protruding cooling element in the first portion and the direction of extension, and the second portion comprises a second secondary draft angle formed between the second transverse side of the protruding cooling element in the second portion and the direction of extension. In addition, the first primary draft angle is identical to the first secondary draft angle, and the second primary draft angle is identical to the second secondary draft angle. Where appropriate, if the protruding cooling element comprises a third portion, the third portion then comprises a third secondary draft angle formed between the second transverse side of the protruding cooling element in the third portion and the direction of extension, and the third primary draft angle is identical to the third secondary draft angle.

According to one variant, the heat sink comprises at least one upper protruding cooling element and one lower protruding cooling element,
and the upper and lower protruding cooling elements are aligned and extend in the same direction of extension, facing opposite ways.

In particular, each of the upper and lower protruding cooling elements comprises a foot and a free end, and the foot of each of the upper and lower protruding cooling elements rests on an opposite face along the direction of extension of a base plate of the heat sink. The upper and lower protruding cooling elements therefore extend on either side of the base plate.

Where appropriate, the upper and lower protruding cooling elements each have a height taken along the direction of extension. According to a first variant, the height of the upper protruding cooling element is equal to the height of the lower protruding cooling element. According to a second variant, the height of the upper protruding cooling element is different from the height of the lower protruding cooling element.

The height of the protruding cooling elements is thus adapted to the space available in the luminous module into which the heat sink is incorporated.

According to one variant, the heat sink comprises a parting plane extending in a longitudinal plane, perpendicular to the direction of extension.

The parting plane corresponds to the joint zone of the two parts of the mold. In particular, the upper and lower fins extend on either side of the parting plane. Preferably, the base plate of the heat sink is in the parting plane.

According to a second object, the invention proposes a luminous module for an automotive vehicle comprising a heat sink according to the first object of the invention.

According to one variant, the luminous module comprises:
at least one light source configured to emit a light beam;
at least one printed circuit board on which the light source is arranged;
at least one optical element configured to divert and/or project the light beam emitted by the light source;
and the heat sink is configured to cool said at least one light source.

According to one variant, the printed circuit board is arranged on the heat sink. The heat sink is thus in indirect contact with the light source(s), which allows effective cooling of the light sources.

According to one variant, the parting plane of the heat sink is parallel to the printed circuit board.

### BRIEF DESCRIPTION OF THE DRAWINGS

Further features and advantages of the invention will become more clearly apparent upon reading the following description, which is given by way of illustrative and non-limiting example, and from the appended drawings, in which:

FIG. 1 shows a heat sink according to a first object of the invention, comprising a plurality of fins;

FIG. 2 shows a cross-sectional rear view of the heat sink shown in FIG. 1;

FIG. 3 schematically shows the fins of the heat sink in FIGS. 1 and 2;

FIG. 4 schematically shows an alternative of the fins of a heat sink according to one variant of the first object of the invention;

FIG. 5 shows a luminous module for an automotive vehicle according to a second object of the invention, comprising a heat sink as described in FIGS. 1 to 3, a reflector and a projection lens; and

FIG. 6 shows the luminous module in FIG. 5, in which the reflector has been removed to reveal a printed circuit board and light sources.

### DETAILED DESCRIPTION OF THE INVENTION

In the description below, longitudinal direction L is given to mean the direction in which the vehicle travels, oriented from the rear to the front, transverse direction T is given to mean the direction that extends transverse to the vehicle and is perpendicular to the longitudinal direction L, and vertical direction V is given to mean the direction that extends from the bottom to the top of the vehicle and is perpendicular to the longitudinal direction L and to the transverse direction T. These directions are represented by the trihedron L, V, T in the figures.

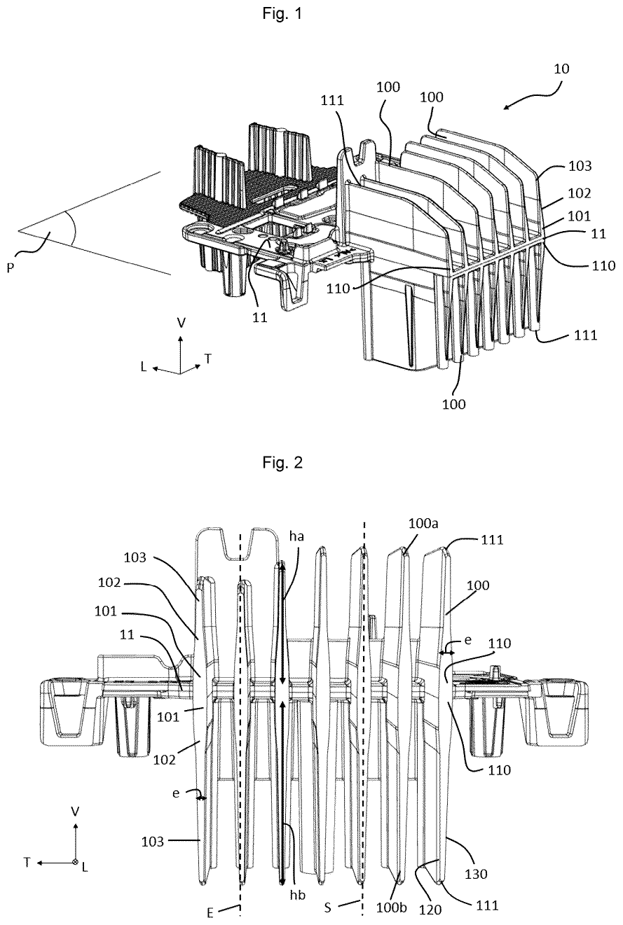

FIG. 1 shows a heat sink 10 of a luminous module for an automotive vehicle. As will be seen below, the heat sink 10 is intended to be mounted in a luminous module 20, in turn intended to be mounted in an automotive vehicle. In the description below, the longitudinal L, transverse T, and vertical V orientations given with reference to the heat sink 10 and to the luminous module 20 correspond to the orientation of the heat sink 10 and the luminous module 20 when they are mounted on the vehicle.

The heat sink 10 comprises a plurality of protruding cooling elements. In the example illustrated, the protruding cooling elements are formed by fins 100. It will be understood that other protruding cooling elements could be used, such as pins for example. In the description below, the term fins will be used to refer to the protruding cooling elements of the heat sink 100.

The heat sink 10 comprises a base plate 11 from which the fins 100 extend. In particular, each fin 100 extends between a foot 110 and a free end 111 along a direction of extension E (shown in FIG. 2), the foot 110 of the fin being situated towards the base plate 11 of the heat sink 10. In the example illustrated, the direction of extension E of the fins 100 corresponds to the vertical direction V.

The heat sink 10 comprises a parting plane P extending in a longitudinal plane, perpendicular to the direction of extension E. The parting plane P corresponds to the plane in which the two parts of the mold used during the injection of the heat sink 10 meet. Preferably, the base plate 11 of the heat sink 11 is in the parting plane P.

The fins 100 of the heat sink 10 comprise upper fins 100a and lower fins 100b. The foot 110 of each of the upper 100a and lower 100b fins rests on an opposite face along the direction of extension E of the base plate 11 of the heat sink 10. The upper fins 100a and the lower fins 100b thus extend on either side of the base plate 11 of the heat sink 10.

In particular, the upper fins 100a extend from their feet 110 on an upper face of the base plate 11 upwards in the vertical direction V to their free ends 111, and the lower fins 100b extend from their feet 110 on a lower face of the base plate 11, opposite the upper face of the base plate 11 in the direction of extension E, downwards in the vertical direction V to their free ends 111.

The upper 100a and lower 100b fins are aligned. In other words, each upper fin 100a extends in the same direction of extension E as and facing the opposite way from a lower fin 100b. According to one variant covered by the invention, but not shown, an upper fin 100a could not be aligned with a lower fin 100b, and conversely, a lower fin 100b could not be aligned with an upper fin 100a.

In one variant, not shown, the heat sink 10 could comprise only upper fins 100a or only lower fins 100b.

Each fin 100 comprises a height in the direction of extension E. The height of the fins 100 depends on the space available in the luminous module in which the heat sink 10 is intended to be mounted. The upper fins 100a and/or the lower fins 100b can thus all be the same height ha. Alternatively, the upper fins 100a and/or the lower fins 100b fins can be different heights ha. As illustrated in the non-limiting example shown in FIGS. 1 and 2, several upper fins 100a are the same height ha, while other upper fins 100a are a different height ha, and all of the lower fins 100b are the same height hb, it being understood that some lower fins hb could also be a different heights.

The fins 100, and therefore the upper 100a and lower 100b fins, are distributed along a direction transverse to the direction of extension E. In the example illustrated, the direction transverse to the direction of extension E corresponds to the transverse direction T.

FIG. 2 shows a rear cross-sectional view in a plane defined by the direction of extension and the transverse direction, corresponding in this example to the vertical direction and the transverse direction respectively, of the heat sink 10.

Each fin 100 has a thickness e in the transverse direction. This thickness e is more particularly visible in FIG. 2. This thickness e decreases from the foot 110 of the fin 100 to the free end 111 of the fin 100. In particular, the thickness e of each fin 100 is greater in the vicinity of the foot 110 of the fin 100 than in the vicinity of the free end 111 of the fin 100.

The fins 100 comprise a first portion 101 and a second portion 102. In the example illustrated, the fins 100 further comprise a third portion 103. The first portion 101 is situated between the foot 110 and the second portion 102, the second portion 102 is situated between the first portion 101 and the third portion 103, and the third portion 103 is situated between the second portion 102 and the free end 111. In each of these portions 101, 102, 103, the variation in the thickness e of the fin is different.

The decrease in the thickness e of each fin 100 is greater in the second portion 102 than in the first portion 101. The decrease in the thickness e of the fin 100 in the third portion 103 is less than the decrease in the thickness e of the fin 100 in the second portion 102. In the example illustrated, the decrease in the thickness e of the fin 100 in the third portion 103 is identical to the decrease in the thickness e of the fin 100 in the first portion 101.

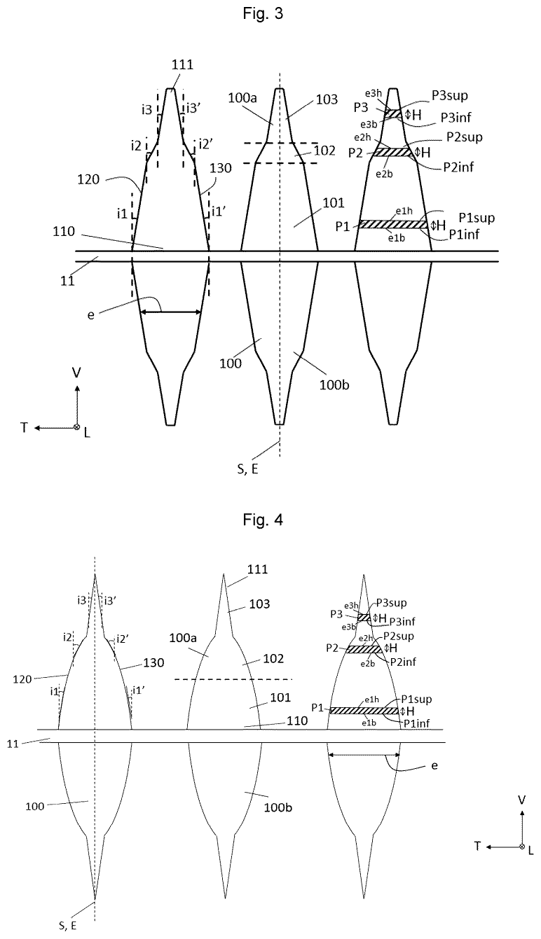

In order to illustrate these variations in thickness e of the fins 100, the fins 100 of the heat sink 10 are shown schematically in FIG. 3. A first part P1 of the first portion 101, a second part P2 of the second portion 102, and a third part P3 of the third portion 103 can be considered on each fin 100, each of these first, second, and third parts P1, P2, P3 having an identical height H, taken along the direction of extension E of the fin 100. Each of the first, second, and third parts P1, P2, P3 is delimited by an upper end P1sup, P2sup, P3sup facing towards the free end 111 of the fin 100, and a lower end P1inf, P2inf, P3inf facing towards the foot 110 of the fin 100. Each upper end P1sup, P2sup, P3sup comprises a thickness e1h, e2h, e3h taken in the transverse direction, and each lower end P1inf, P2inf, P3inf comprises a thickness e1b, e2b, e3b taken in the transverse direction.

Due to the greater decrease in the thickness e of each fin 100 in the second portion 102 than in the first portion 101, the difference between the thickness e1b of the fin 100 at the lower end P1inf of the first part P1 and the thickness e1h of the fin 100 at the upper end P1sup of the first part P1 is greater than the difference between the thickness e2b of the fin 100 at the lower end P2inf of the second part P2 and the thickness e2h of the fin 100 at the upper end P2sup of the second part P2.

Due to the smaller decrease in the thickness e of the fin 100 in the third portion 103 than in the thickness e of the fin 100 in the second portion 102, the difference between the thickness e2b of the fin 100 at the lower end P2inf of the second part P2 and the thickness e2h of the fin 100 at the upper end P2sup of the second part P2 is less than the difference between the thickness e3b of the fin 100 at the lower end P3inf of the third part P3 and the thickness e3h of the fin 100 at the upper end P3sup of the third part P3.

In addition in particular, in the example illustrated, due to the identical decrease in the thickness e of the fin 100 in the third portion 103 and decrease in the thickness e of the fin 100 in the first portion 101, the difference between the thickness e1b of the fin 100 at the lower end P1inf of the first part P1 and the thickness e1h of the fin 100 at the upper end P1sup of the first part P1 is equal to the difference between the thickness e3b of the fin 100 at the lower end P3inf of the third part P3 and the thickness e3h of the fin 100 at the upper end P3sup of the third part P3.

The decrease in thickness e of the fins 100 from their feet 110 towards their free ends 110 is therefore non-constant, which makes it possible to have a sufficiently wide foot 110 to ensure that the material forming the heat sink 10 passes into the mold during injection, while decreasing the thickness of the fin 100 to a greater extent in the second portion 102 in order to obtain a thinner fin 100 more quickly as it extends towards the free end 111 of the fin 100. As the fins 100 are thinner more quickly due to the greater decrease in thickness in the second portion 102, it is possible to position the fins 100 closer to each other at their feet 110, as ultimately the distance between the fins 100 increases more quickly in the second portion 102. Even if it possible that the fins 100 will radiate heat towards each other in line with the first portion 101, this radiation phenomenon will thus then be limited in line with the second portion 102 and the third portion 103. In line with the second portion 102 and the third portion 103, convection is promoted and radiation towards the outside of the heat sink is also promoted.

For each of the first, second, and third portions 101, 102, 103, the decrease in the thickness e of the fin 100 is constant. For the first portion, whichever first part P1 of height H is taken into consideration, the difference between the thickness e1b of the fin 100 at the lower end P1inf of the first part P1 and the thickness e1h of the fin 100 at the upper end P1sup of the first part P1 is identical. Likewise, for the second portion 102, whichever second part P2 of height H is taken into consideration, the difference between the thickness e2b of the fin 100 at the lower end P2inf of the second part P2 and the thickness e2h of the fin 100 at the upper end P2sup of the second part P2 is identical. Likewise, for the third portion 103, whichever third part P3 of height H is taken into consideration, the difference between the thickness e3b of the fin 100 at the lower end P3inf of the third part P3 and the thickness e3h of the fin 100 at the upper end P3sup of the third part P3 is identical.

Each fin 100 comprises a first transverse side 120 and a second transverse side 130 opposite the first transverse side 120. In particular, the first and second transverse sides correspond to the edges of the fin 100 taken on a cross-section of the fin 100 in a plane comprising the direction of extension E and the transverse direction T, corresponding to the section plane in FIG. 2, and to the plane in which the fins 100 are schematically shown in FIG. 3.

The first transverse side 120 is symmetrical to the second transverse side 130 with respect to an axis of symmetry S parallel to the direction of extension.

Due to the constant decrease in the thickness e of the fin 100 in each of the first, second, and third portions 101, 102, 103, the first and second transverse sides 120, 130 are formed by a straight-line segment for each of the first, second, and third portions. The first portion 101 thus comprises a first primary draft angle i1 formed between the first transverse side 120 of the fin 100 in the first portion 101 and the direction of extension E, the second portion 102 comprises a second primary draft angle i2 formed between the first transverse side 120 of the fin 100 in the second portion 102 and the direction of extension E, and the third portion 103 comprises a third primary draft angle i3 formed between the first transverse side 120 of the fin 100 in the third portion 103 and the direction of extension E.

The first primary draft angle i1 is smaller than the second primary draft angle i2, and the third primary draft angle i3 is smaller than the second primary draft angle i2, and in particular, in the example illustrated, the third primary draft angle i3 is identical to the first primary draft angle i1.

Through symmetry, the draft angle along the second transverse side 130 of each fin 100 follows the same evolution as the draft angle along the first transverse side 120 of the fin. In particular, the first portion 101 comprises a first secondary draft angle i1′ formed between the second transverse side 130 of the fin 100 in the first portion 101 and the direction of extension E, the second portion 102 comprises a second secondary draft angle i2′ formed between the second transverse side 130 of the fin 102 in the second portion 102 and the direction of extension, and the third portion 103 comprises a third secondary draft angle i3′ formed between the second transverse side 130 of the fin in the third portion 103 and the direction of extension E.

The first primary draft angle i1 is identical to the first secondary draft angle i1', the second primary draft angle i2 is identical to the second secondary draft angle i2′, and the third primary draft angle i3 is identical to the third secondary draft angle i3′.

FIG. 4 schematically shows an alternative shape of the fins 100 of the heat sink 10. The fins 100 shown in FIG. 4 differ from those shown in the other figures only in that the decrease in the thickness e of the fin 100 in the first portion 101 and in the second portion 102 is non-constant. In the example shown, the decrease in thickness e of the fins 100 is constant in the third portion 103.

Only the non-constant decrease in the thickness e in the first portion 101 and the second portion 102 will be explained in the description below, it being understood that in all other respects, the description of the fins 100 given with reference to FIGS. 1 to 3, and in particular, the description given of the third portion 103, applies to the fins 100 in FIG. 4.

As the decrease in thickness e of the fins 100 is non-constant, for the first portion 101, the difference between the thickness elb of the fin 100 at the lower end P1inf of the first part P1 and the thickness e1h of the fin 100 at the upper end P1sup of the first part P1 is different depending on which first part P1 is taken into consideration. Likewise, for the second portion 102, the difference between the thickness e2b of the fin 100 at the lower end P2inf of the second part P2 and the thickness e2h of the fin 100 at the upper end P2sup of the second part P2 is different depending on which second part P2 is taken into consideration.

Due to the non-constant decrease in the thickness e of the fins 100 in the first portion 101 and in the second portion 102, the first and second transverse sides 120, 130 are formed by a continuous curve for the first and second portions.

The first portion 101 comprises a first primary draft angle i1 formed between the tangent to the first transverse side 120 of the fin 100 in the first portion 101 and the direction of extension E, and the second portion 102 comprises a second primary draft angle i2 formed between the tangent to the first transverse side 120 of the fin 100 in the second portion 102 and the direction of extension E. The first primary draft angle i1 and the second primary draft angle i2 evolve along the first transverse side 120. In particular, the first primary draft angle i1 and the second primary draft angle i2 increase as the tangent to the first transverse side 120 taken into consideration extends away from the base plate 11 of the heat sink 10.

The third primary draft angle i3 is smaller than the second primary draft angle i2. In particular, the second portion 102 can be defined by a portion in which all of the second primary draft angles i2 are smaller than the third primary draft angle i3. In this case, the portion located between the second portion 102 defined in this way and the foot 110 of the fin 100 forms the first portion 101.

Through symmetry, the draft angle along the second transverse side 130 of each fin 100 follows the same evolution as the draft angle along the first transverse side 120 of the fin.

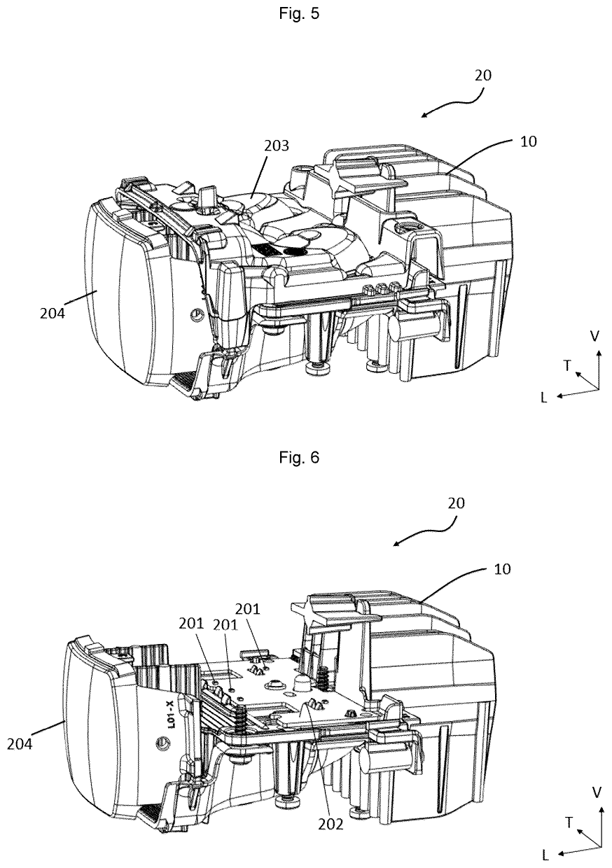

FIGS. 5 and 6 show a luminous module 20 for an automotive vehicle in which the heat sink 10 is mounted. This luminous module 20 is intended to be mounted in an automotive vehicle headlamp.

The luminous module 20 comprises a plurality of light sources 201 configured to emit a light beam, together with a printed circuit board 202 on which the light sources 201 are arranged. The heat sink 10 makes it possible to cool the light sources 201. The printed circuit board 202 rests on the heat sink 10. In this example, the parting plane P of the heat sink 10 is parallel to the printed circuit board 202.

The luminous module 20 comprises a first optical element in the form of a reflector 203 and a second optical element in the form of a projection lens 204. The reflector 203 is intended to receive the light beam emitted by the light sources 201 and to reflect this light beam towards the projection lens 204. The projection lens 204 makes it possible to project the light beam reflected by the reflector 203 onto the road on which the vehicle is travelling.

What is claimed is:

1. A heat sink of a luminous module for an automotive vehicle, comprising at least one protruding cooling element extending between a foot and a free end along a direction of extension, and having a thickness along a direction transverse to the direction of extension, the thickness of the protruding cooling element decreasing as it extends from the foot to the free end
with the protruding cooling element including a first portion and a second portion, the first portion being situated between the foot and the second portion, and the second portion being situated between the first portion and the free end,
the decrease in the thickness of the protruding cooling element being greater in the second portion than in the first portion.

2. The heat sink as claimed in the claim 1, further comprising a plurality of protruding cooling elements along the transverse direction.

3. The heat sink as claimed in claim 1, wherein the protruding cooling element is formed by a fin or a pin.

4. The heat sink as claimed in claim 1, wherein the protruding cooling element includes a third portion situated between the second portion and the free end, the decrease in the thickness of the protruding cooling element in the third portion being less than the decrease in the thickness of the protruding cooling element in the second portion.

5. The heat sink as claimed in claim 1, wherein the decrease in the thickness of the protruding cooling element is constant in the first portion and in the second portion.

6. The heat sink as claimed in claim 1, wherein the protruding cooling element includes a first transverse side and a second transverse side, opposite the first transverse side, the first transverse side being symmetrical to the second transverse side with respect to an axis of symmetry parallel to the direction of extension.

7. The heat sink as claimed in claim 1, further comprising at least one upper protruding cooling element and one lower protruding cooling element,
and wherein the upper and lower protruding cooling elements are aligned and extend in the same direction of extension, facing opposite ways.

8. The heat sink as claimed in claim 1, further comprising a parting plane extending in a longitudinal plane, perpendicular to the direction of extension.

9. A luminous module for an automotive vehicle, comprising a heat sink, with the heat sink including at least one protruding cooling element extending between a foot and a free end along a direction of extension, and having a thickness along a direction transverse to the direction of extension, the thickness of the protruding cooling element decreasing as it extends from the foot to the free end with the protruding cooling element including a first portion and a second portion, the first portion being situated between the foot and the second portion, and the second portion being situated between the first portion and the free end, the decrease in the thickness of the protruding cooling element being greater in the second portion than in the first portion.

10. The luminous module as claimed in claim 9, further comprising:
at least one light source configured to emit a light beam;
at least one printed circuit board on which the light source is arranged;
at least one optical element configured to divert and/or project the light beam emitted by the light source;
and wherein the heat sink is configured to cool the at least one light source.
